(19) United States
(12) Patent Application Publication
(10) Pub. No.: US 2005/0195350 A1
(43) Pub. Date: Sep. 8, 2005

(54) Active matrix liquid crystal display

(75) Inventor: Chien-Ting Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/071,388

(22) Filed: Mar. 2, 2005

(30) Foreign Application Priority Data
Mar. 2, 2004 (TW) 93105376

(51) Int. Cl. G02F 1/1335

(52) U.S. Cl. 349/137

(57) ABSTRACT

An active matrix liquid crystal display comprises a plurality of pixel regions, each pixel region comprises two anti-reflective data lines (11, 12) arranged along a longitudinal direction, two anti-reflective gate lines (13, 14) arranged transverse to the data lines, a pixel electrode (15), and a thin film transistor. The date lines and the gate lines cooperatively define a pixel electrode region. The thin film transistor has a source electrode (16) connected to one of the data lines, a gate electrode (17) connected to one of the gate lines and a drain electrode (18) connected to the pixel electrode. Further, the active matrix liquid crystal display has a high contrast ratio.

### BACKGROUND OF THE INVENTION

1. Field of the Invention

The present invention relates to active matrix liquid crystal displays, and particularly to such displays utilizing anti-reflective materials therein.

2. General Background

LCDs are generally categorized by their driving modes into active matrix LCDs and passive matrix LCDs. Compared with passive matrix LCDs, active matrix LCDs generally have faster response speeds, better color displays, and higher contrast ratios. For these reasons, active matrix LCDs are more popular than passive matrix LCDs.

Active matrix LCDs are usually categorized, according to the manner in which they transport light, into reflective mode, transmissive mode and transflective mode active matrix LCDs. Though reflective mode, transmissive mode and transflective mode active matrix LCDs adopt different modes of transporting light, they all use thin film transistors (TFTs) to achieve an active display.

In general, an active matrix LCD includes a multiplicity of pixel regions, each of which comprises a plurality of parallel data lines, a plurality of parallel gate lines, a plurality of TFTs, and a plurality of pixel electrodes. The data lines are perpendicular to the gate lines, thereby forming the pixel region. Each of the TFTs includes a gate electrode connected with one of the gate lines, a source electrode connected with one of the data lines, and a drain electrode connected with the pixel electrode. The pixel electrodes cover parts of the data lines and the gate lines. A conventional reflective active matrix LCD having similar pixel regions is disclosed in U.S. Pat. No. 6,509,943 issued on Jan. 21, 2003. A conventional transflective active matrix LCD having similar pixel regions is disclosed in U.S. Pat. No. 6,614,496 issued on Sep. 2, 2003.

As described above, the pixel electrodes cover parts of the data lines and the gate lines, so that some parts of the data lines and the gate lines are not covered by the pixel electrodes. The data lines and the gate lines are typically made of a metal such as aluminum or silver, therefore the parts not covered by the pixel electrodes may have the disadvantage of reflecting light. Thus, the contrast ratio of the active matrix LCD may be reduced.

To solve the above problem, in general, a black matrix is arranged in a color filter of the active matrix LCD. The black matrix corresponds to the data lines and the gate lines, and is used to shield light reflected by the data lines and the gate lines. However, the black matrix may reduce an aperture ratio of the active matrix LCD.

What is needed, therefore, is an active matrix liquid crystal display which has a high contrast ratio and a high aperture ratio.

### SUMMARY

In one embodiment herein, an active matrix liquid crystal display comprises a plurality of pixel regions, each pixel region comprises two anti-reflective data lines arranged along a longitudinal direction, two anti-reflective gate lines arranged transverse to the data lines, a pixel electrode, and a thin film transistor. The date lines and the gate lines cooperatively define a pixel electrode region. The thin film transistor has a source electrode connected to one of the data lines, a gate electrode connected to one of the gate lines and a drain electrode connected to the pixel electrode.

Because the data lines and the gate lines are anti-reflective, and can prevent lights from being reflected, hence that a contrast ratio of the active matrix liquid crystal display is increased.

Further, the black matrix corresponding to the data lines and the gate lines need not necessarily be provided for the active matrix liquid crystal display. That is, a structure and a manufacturing process of a color filter of the active matrix liquid crystal display are simplified.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a schematic, top plan view of a pixel region of an active matrix LCD according to a first embodiment of the present invention;

FIG. 2 is an enlarged, schematic side view of a first embodiment of an anti-reflective film stack used for data lines and gate lines of the active matrix LCD of the present invention;

FIG. 3 is an enlarged, schematic abbreviated side view of a second embodiment of an anti-reflective film stack used for data lines and gate lines of the active matrix LCD of the present invention; and

FIG. 4 is a schematic, top plan view of a pixel region of an active matrix LCD according to a second embodiment of the present invention.

### DETAILED DESCRIPTION OF THE PREFERRED EMBODIMENTS

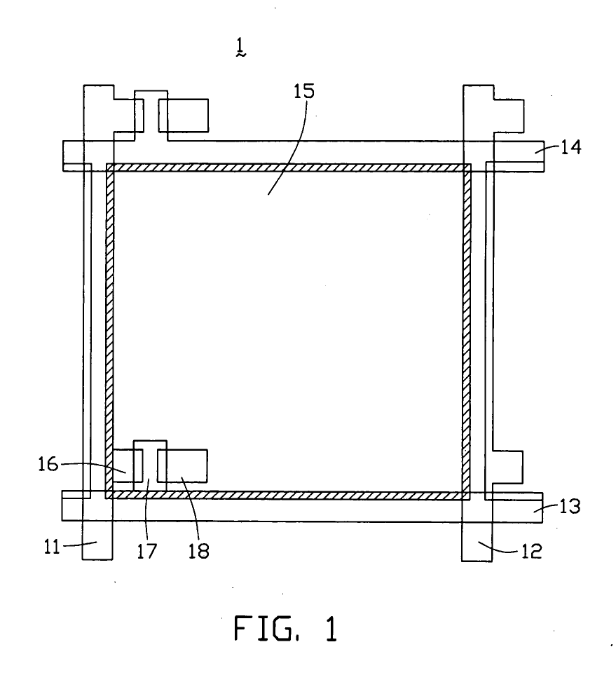

Referring to FIG. 1, an active matrix liquid crystal display of a first embodiment of the present invention is a reflective mode liquid crystal display. A pixel region 1 of the first embodiment includes two data lines 11, 12 arranged along a longitudinal direction, two gate lines 13, 14 arranged along a direction transverse to the data lines 11, 12, a pixel electrode 15, and a switching element (not labeled).

The data lines 11, 12 and the gate lines 13, 14 define a pixel electrode region therebetween. The pixel electrode 15 is substantially a reflective electrode, which is arranged in the pixel electrode region and covers portions of the data lines 11, 12 and the gate lines 13, 14. The switching element may be a thin film transistor, which includes a source electrode 16 connected to one of the data lines 11, a gate electrode 17 connected to one of the gate lines 13, and a drain electrode 18 connected to the pixel electrode 15.

In this embodiment, to increase the contrast ratio of the active matrix liquid crystal display, the data lines 11, 12 and the gate lines 13, 14 are anti-reflective. For example, the data lines 11, 12 and the gate lines 13, 14 may comprise anti-reflective films, which can prevent light from being reflected.

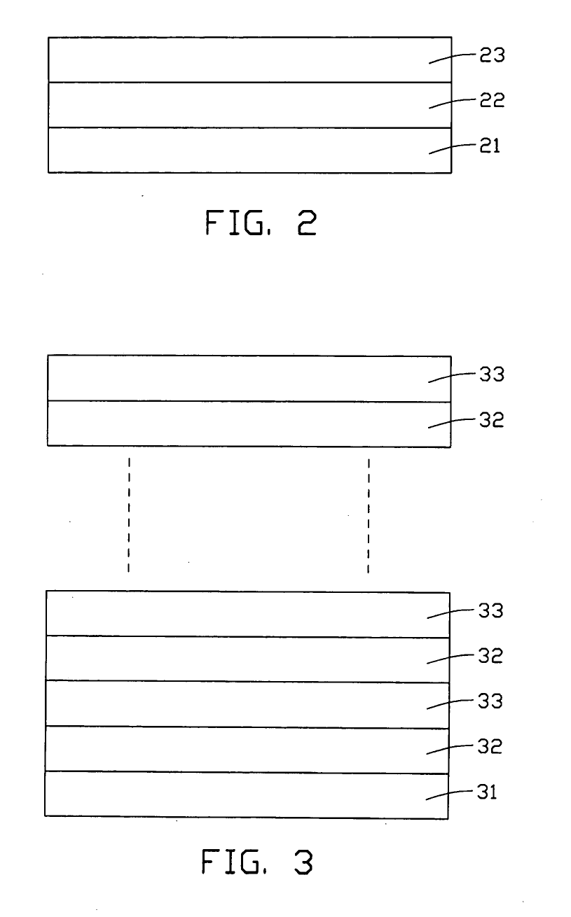

A first embodiment of an anti-reflective film stack is shown in FIG. 2. The anti-reflective film stack has multiple layers of film, and comprises a chromium film 21, a chromium oxide film 22, and a chromium nitride film 23 arranged in the order from bottom to top. The chromium film 21 is an electrically conductive film. Alternatively, the multi-layer film stack may comprise a chromium film 21, a chromium nitride film 23, and a chromium oxide film 22 arranged in that order.

A second embodiment of an anti-reflective film stack is shown in FIG. 3. The anti-reflective film stack has multiple layers of film, and comprises a chromium film 31, a plurality of chromium oxide films 32, and a plurality of chromium nitride films 33. The chromium oxide films 32 and the chromium nitride films 33 are alternately arranged one on the other on top of the chromium film 31.

Further, because the data lines 11, 12 and the gate lines 13, 14 are anti-reflective, a black matrix corresponding to the data lines and the gate lines need not necessarily be provided for the active matrix liquid crystal display. That is, a structure and a manufacturing process of a color filter of the active matrix liquid crystal display are simplified.

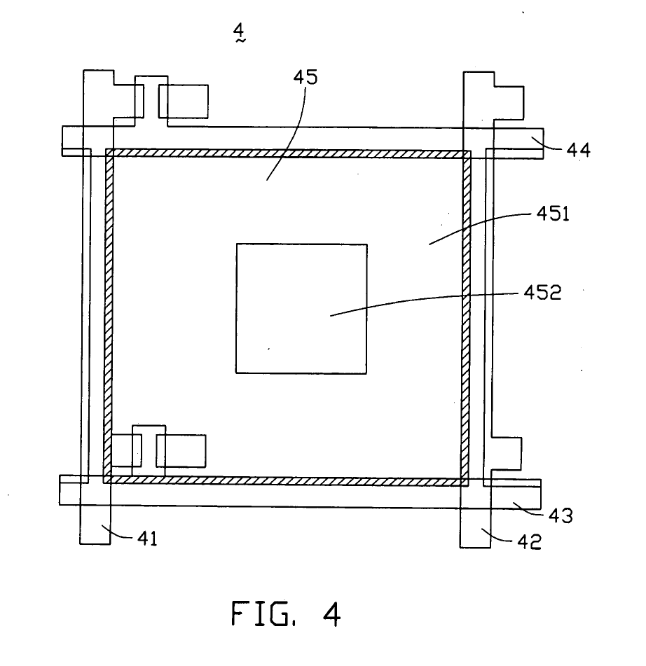

Referring to FIG. 4, an active matrix liquid crystal display of a second embodiment of the present invention is a transflective mode liquid crystal display. A pixel region 4 of the second embodiment includes two data lines 41, 42 arranged along a longitudinal direction, two gate lines 43, 44 arranged along a direction transverse to the data lines 41, 42, a pixel electrode 45, and a thin film transistor (not labeled).

The pixel region 4 is substantially similar to the pixel region 1 of the first embodiment. The pixel electrode 45 includes a reflective region 451 and a transmissive reflective region 452. Light is reflected by the reflective region 451, and can pass through the transmissive reflective region 452.

Further, the active matrix liquid crystal display of another embodiment of the present invention may be a transparent mode liquid crystal display. In such case, the pixel electrode of the transparent mode liquid crystal display is a transparent electrode.

While the present invention has been described with reference to particular embodiments, the descriptions are illustrative of the invention and are not to be construed as limiting the invention. Therefore, various modifications of the described embodiments can be made by those skilled in the art without departing from the true spirit and scope of the invention as defined by the appended claims.

1. An active matrix liquid crystal display which comprises a plurality of pixel regions, each pixel region comprising:
two anti-reflective data lines arranged along a longitudinal direction;
two anti-reflective gate lines arranged transverse to the data lines, the anti-reflective data lines and the anti-reflective gate lines cooperatively defining a pixel electrode region; and
a pixel electrode arranged in the pixel electrode region.

2. The active matrix liquid crystal display of claim 1, wherein the anti-reflective data lines and the anti-reflective gate lines comprise anti-reflective films.

3. The active matrix liquid crystal display of claim 2, wherein the anti-reflective films comprise multi-layer film stacks, and each film stack comprises a chromium film, a chromium oxide film, and a chromium nitride film arranged in that order.

4. The active matrix liquid crystal display of claim 2, wherein the anti-reflective films comprise multi-layer film stacks, and each film stack comprises a chromium film, a chromium nitride film, and a chromium oxide film arranged in that order.

5. The active matrix liquid crystal display of claim 2, wherein the anti-reflective films comprise multi-layer film stacks, and each film stack comprises a chromium film, and a plurality of chromium nitride films and a plurality of chromium oxide films alternately arranged one on the other on top of the chromium film.

6. The active matrix liquid crystal display of claim 1, wherein the pixel electrode covers portions of the anti-reflective data lines and the anti-reflective gate lines.

7. The active matrix liquid crystal display of claim 1, wherein the pixel electrode is a reflective electrode.

8. The active matrix liquid crystal display of claim 1, wherein the pixel electrode comprises a transmissive region and a reflective region.

9. The active matrix liquid crystal display of claim 1, wherein the pixel electrode is a transparent electrode.

10. An active matrix liquid crystal display which comprises a plurality of pixel regions, each pixel region comprising:
two anti-reflective data lines arranged along a longitudinal direction;
two anti-reflective gate lines arranged transverse to the data lines, the anti-reflective data lines and the anti-reflective gate lines cooperatively defining a pixel electrode region;
a pixel electrode arranged in the pixel region; and
a thin film transistor, which comprises a source electrode connected to one of the data lines, a gate electrode connected to one of the gate lines, and a drain electrode connected to the pixel electrode.

11. The active matrix liquid crystal display of claim 10, wherein the anti-reflective data lines and the anti-reflective gate lines comprise anti-reflective films.

12. The active matrix liquid crystal display of claim 11, wherein the anti-reflective films comprise multi-layer film stacks, and each film stack comprises a chromium film, a chromium oxide film, and a chromium nitride film arranged in that order.

13. The active matrix liquid crystal display of claim 11, wherein the anti-reflective films comprise multi-layer film stacks, and each film stack comprises a chromium film, a chromium nitride film, and a chromium oxide film arranged in that order.

14. The active matrix liquid crystal display of claim 11, wherein the anti-reflective films comprise multi-layer film stacks, and each film stack comprises a chromium film, and a plurality of chromium nitride films and a plurality of chromium oxide films alternately arranged one on the other on top of the chromium film.

15. The active matrix liquid crystal display of claim 10, wherein the pixel electrode covers portions of the anti-reflective data lines and the anti-reflective gate lines.

16. The active matrix liquid crystal display of claim 10, wherein the pixel electrode is a reflective electrode.

17. The active matrix liquid crystal display of claim 10, wherein the pixel electrode comprises a transmissive region and a reflective region.

18. The active matrix liquid crystal display of claim 10, wherein the pixel electrode is a transparent electrode.

19. A reflective mode active matrix liquid crystal display which comprises a plurality of pixel regions, each of the pixel regions comprising:
two anti-reflective data lines arranged along a longitudinal direction;
two anti-reflective gate lines arranged transverse to the data lines, the anti-reflective data lines and the anti-reflective gate lines cooperatively defining a pixel electrode region; and
a reflective pixel electrode arranged in the pixel electrode region.

20. The active matrix liquid crystal display of claim 19, wherein the anti-reflective data lines and the anti-reflective gate lines comprise anti-reflective films.

21. The active matrix liquid crystal display of claim 20, wherein the anti-reflective films comprise multi-layer film stacks, and each film stack comprises a chromium film, a chromium oxide film, and a chromium nitride film arranged in that order.

22. The active matrix liquid crystal display of claim 20, wherein the anti-reflective films comprise multi-layer film stacks, and each film stack comprises a chromium film, a chromium nitride film, and a chromium oxide film arranged in that order.

23. The active matrix liquid crystal display of claim 20, wherein the anti-reflective films comprise a multi-layer film stacks, and each film stack comprises a chromium film, and a plurality of chromium nitride films and a plurality of chromium oxide films alternately arranged one on the other on top of the chromium film.

24. The active matrix liquid crystal display of claim 19, wherein the reflective pixel electrode covers portions of the anti-reflective data lines and the anti-reflective gate lines.
